(19) United States
(12) Patent Application Publication
(10) Pub. No.: US 2023/0048938 A1
(43) Pub. Date: Feb. 16, 2023

(54) GENERATING ACTIONABLE INSIGHT INTERFACES DERIVED FROM BUSINESS DATA SETS

(71) Applicant: Narrative Bl, Inc., Middletown, DE (US)

(72) Inventors: Aliaksei Vertsel, Redwood City, CA (US); Yury Koleda, Minsk (BY); Yury Bolkonskiy, Moscow (RU)

(73) Assignee: Narrative Bl, Inc., Middletown, DE (US)

(21) Appl. No.: 17/880,331

(22) Filed: Aug. 3, 2022

Related U.S. Application Data
(60) Provisional application No. 63/228,719, filed on Aug. 3, 2021.

(51) Int. Cl. G06Q 10/06; G06F 3/01

(52) U.S. Cl. CPC G06Q 10/06393; G06F 3/01

(57) ABSTRACT

Systems and methods are described for deriving actionable insight interfaces from received data sets using performance indicators and stored insight templates. A server may tag data columns of the data set, which may be then mapped to a plurality of performance indicator inputs to determine a plurality of performance indicators. A selected insight template may then be retrieved from a template database based on the determined performance indicators matching input requirements of the selected insight template. Each insight template stored within the template database may be stored as a data object that includes a plurality of rules and narrative text that provides a text recommendation based on the rule outputs. After the rules for the selected insight template have been executed, the narrative text and the rule outputs may be transmitted to a display device for display on an insight graphic interface.

### CROSS-REFERENCE TO RELATED APPLICATIONS

This application claims priority to provisional U.S. Patent Application No. 63/228,719, filed on Aug. 3, 2021 and entitled “Generating Actionable Insight Interfaces Derived From Business Data Sets,” which is incorporated herein in its entirety.

### TECHNICAL FIELD

This disclosure relates generally to the technical field of computer-implemented methods for linking data with visualizations. Specifically, the disclosure describes stored templates from a database to data sets received over a network connection to determine performance indicators and automatically generate insight visualizations based on the outputs of the performance indicators.

### SUMMARY OF THE INVENTION

Systems and methods are described for deriving actionable insight interfaces from received data sets using performance indicators and stored insight templates. A server may tag data columns of the data set, which is received from a client device over a network connection. The tagged data columns may be then mapped to a plurality of performance indicator inputs to determine a plurality of performance indicators. A selected insight template may then be retrieved, by the server, from a plurality of insight templates stored within a template database. The retrieved insight template may be selected based on the determined performance indicators matching input requirements of the selected insight template. Each insight template stored within the template database may be stored as a data object that includes a plurality of rules. Each rule may receive performance indicators as inputs and derive rule outputs from the received performance indicators. The data object of each insight template may also include narrative text that provides a text recommendation based on the rule outputs.

The server may then execute the rules included within the selected insight template using the determined plurality of performance indicators for the received data set. After the rules have been executed, the server may transmit, via the network connection, the narrative text and the rule outputs to a display device. The server may then cause an insight graphic interface to be displayed by the display device, where the insight graphic interface includes the text recommendation. Additional embodiments may include methods for creating additional templates, and other useful features.

### BRIEF DESCRIPTION OF THE FIGURES

This disclosure is illustrated by way of example and not limitation in the figures of the accompanying drawings, in which like references indicate similar elements, and in which:

FIG. 1 is a block diagram illustrating an example operating environment for deriving and applying insight templates to received data sets, according to one or more embodiments of the disclosure.

FIG. 2 is a flow diagram illustrating an example method of generating and displaying an insight graphic interface according to one or more embodiments of the disclosure.

FIG. 3 is a block diagram of a virtual company model linking data sources and performance indicators according to one or more embodiments of the disclosure,

FIG. 4 is a block diagram illustrating data mapping using data sets formatted using preexisting data templates according to one or more embodiments of the disclosure.

FIG. 5 is a block diagram illustrating an exemplary insight data structure according to one or more embodiments of the disclosure.

FIGS. 6A-D show exemplary insight templates according to one or more embodiments of the disclosure.

FIG. 7 is a screenshot illustrating configurable settings for a insight template according to one or more embodiments of the disclosure.

FIG. 8 is a flow diagram illustrating an example method of utilizing user feedback for insight templates according to one or more embodiments of the disclosure.

FIG. 9 is a screenshot illustrating an insight graphic interface according to one or more embodiments of the disclosure.

FIG. 10 is a block diagram illustrating an example computing system that may be used in conjunction with one or more embodiments of the disclosure.

### DETAILED DESCRIPTION

Legacy business intelligence (“B1”) systems and dashboards are descriptive: they require further interpretation by a data-savvy professional. Actionable Insights described herein may track past decisions, plan actions, and mark events on the timeline for adoption (by providing relevant insights and/or actionable recommendations). Businesses may have several very similar parts (e.g. marketing, sales, salaries, taxes, expenses) and as a result very similar key performance indicators (KPIs) for these metrics. A high level virtual model of a business may allow business users to see as many KPIs as possible depending on the amount of input data and mapping of input data to virtual model inputs. As a result, generated insights may be based on real business KPIs and can be converted to recommendations presented on a graphic user interface.

Methods and systems for users to generate actionable recommendations for insight using internal virtual company model (VCM) and actionable templates for specific company states for specific or general verticals are described herein. The data set may be tagged, and then mapped to a set of performance indicator expressions. Key performance indicators (KPIs) may be determined based on the mapped data set. Using the mapped data set, a virtual company model may then be generated, where the virtual company model is a graph with data sources variables) acting as root nodes and performance indicators on leaf nodes. Once the system calculates all available KPIs—all the results together are stored as a company performance snapshot. These snapshots are used to match actionable recommendation templates against them.

Subsequently, a database of actionable insight templates may be accessed, where each template contains multiple rules which apply restrictions on the current company performance snapshot. Specific templates may be selected from the database based on the specific templates matching data in the performance snapshot by a matching module. The specific templates may then be applied to the mapped data set to automatically generate one or more actionable insight interfaces. The actionable insight interfaces may be displayed on a display of a computer system, where each actionable insight interface includes one or more recommendations derived from the application of the specific templates to the mapped data set.

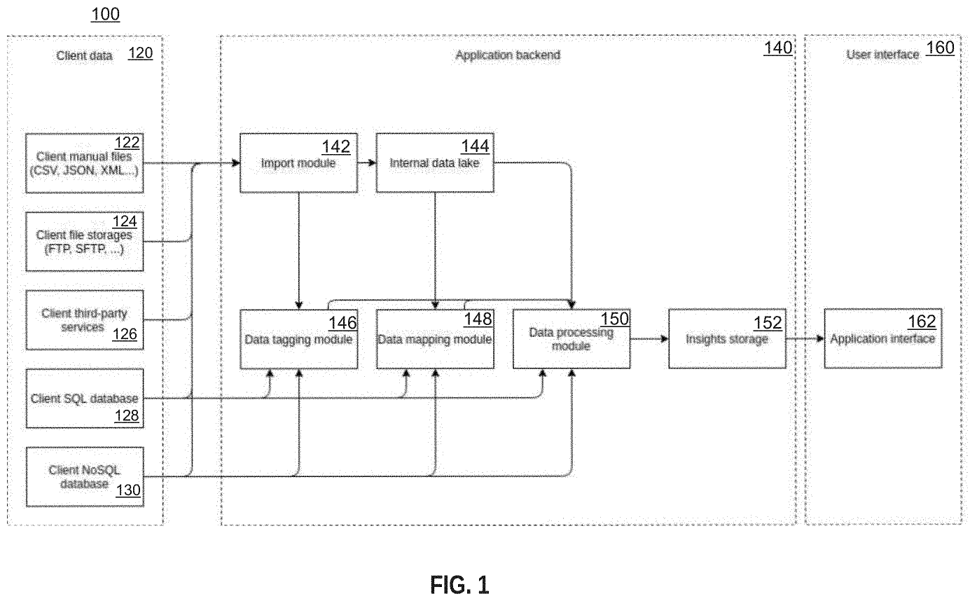

More specifically, and with reference to FIG. 1, shown is a block diagram illustrating an example of an operating environment 100 for deriving and applying insight templates to received data sets, according to one or more embodiments of the disclosure. As shown, the operating environment 100 may include a client system 120, an application back end 140, and a user interface 160. It should be noted that the components of operating environment 100 may interact via network connections, which may be any type of wired or wireless network including a local area network (LAN), a wide area network (WAN), or a direct communication link, or other suitable connection.

The communications network used by elements 120, 140, and 160 to communicate may itself be comprised of many interconnected computer systems and communication links. The communications links may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, the communication network is the Internet, in other embodiments, the communication network may be any suitable communication network including a local area network (LAN), a wide area network (WAN), a wireless network, a intranet, a private network, a public network, a switched network, and combinations of these, and the like.

Client data systems 120 may include client manual files 122, client file storages 124, third party data storage services 126, SQL databases 128, and/or non-SQL databases 130, and 115 allow users to access and query information stored by server system 120. The application backend 140 may include import module 142 to retrieve data from the client data sources 120. The import module 142 may be communicatively coupled to internal data lake 144 and data tagging module 146, whose operation is described in greater detail below. The tagging module 146 and data lake 144 may operate together with data mapping module 148 and data processing module 150 to generate a tagged and mapped version of a data set received from one or more of the client data sources 120. The output tagged and mapped data set may be then matched to various insight templates stored in insights storage 152 to generate an insight graphical interface, which may be transmit to the application interface 162 of the user interface 160.

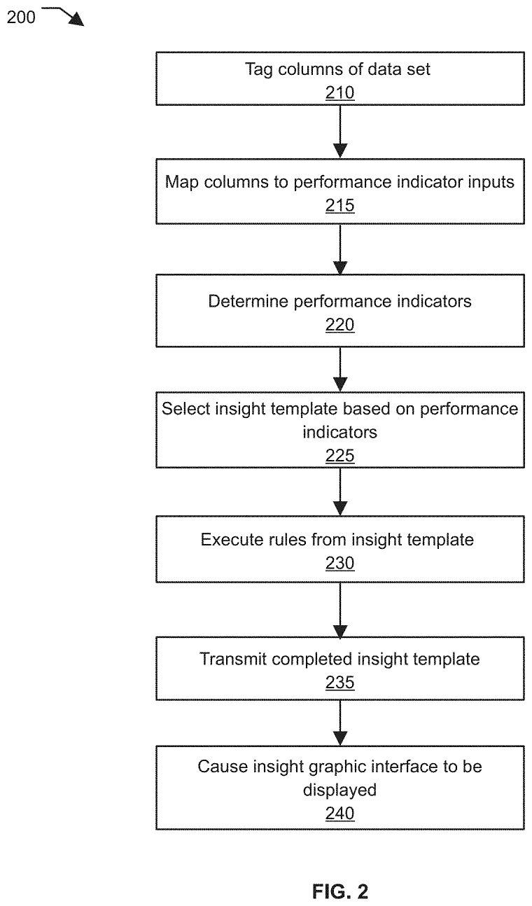

FIG. 2 is a flow diagram illustrating an example method 200 of generating and displaying an insight graphic interface according to one or more embodiments of the disclosure. Process 200 may use processing logic, which may include software, hardware, or a combination thereof. For example, process 200 may be performed by a system including one or more components described in operating environment 100.

In block 210, a server (e.g. application backend 140) may tag data columns of a data set, which is received from a client device (e.g. one of client data sources 120) over a network connection. The data tagging system allows each data column to be associated with specific data types and dimensional/categorical data. The dimensional/categorical data may be used for data interpretation by various internal algorithms. Examples of data columns with their data types and dimensions are listed below:

```
{
  “datatype[CLIENT_NAME/tasks/_id]”: “id”,
  “property[CLIENT_NAME/tasks/_id]”: “dimension”,
  “datatype[CLIENT_NAME/courses/_id]”: “id”,
  “property[CLIENT_NAME/courses/_id]”: “dimension”,
  “datatype[CLIENT_NAME/payments/price]”: “numerical”,
  “datatype[CLIENT_NAME/tasks/title.en]”: “categorical”,
  “datatype[CLIENT_NAME/tasks/title.ru]”: “categorical”,
  “property[CLIENT_NAME/payments/price]”: “metric”,
  “property[CLIENT_NAME/tasks/title.en]”: “dimension”,
  “property[CLIENT_NAME/tasks/title.ru]”: “dimension”,
  “datatype[CLlENT_NAME/courses/name.en]”: “categorical”,
  “datatype[CLIENT_NAME/courses/name.ru]”: “categorical”,
  “datatype[CLIENT_NAME/payments/userID]”: “id”,
  “property[CLIENT_NAME/courses/name.en]”: “dimension”,
  “property[CLIENT_NAME/courses/name.ru]”: “dimension”,
  “property[CLIENT_NAME/payments/userID]”: “dimension”,
  “datatype[CLIENT_NAME/payments/created]”: “datetime”,
  “property[CLIENT_NAME/payments/created]”: “dimension”
}
```

The tagged data columns may be then mapped to a plurality of performance indicator inputs at block 215. The data mapping system may map any kind of client's data to the corresponding system inputs (variables) and lets the system calculate KPIs based on such variables. Each variable can be represented by several data columns. In that case, the system decides which data column should be used for specific KPI calculations depending on other variables involved in the calculation. An example of the commands that may be used to implement the mapping:

```
{
  “columns[USER_ID]”: [ “CLIENT_NAME/payments/userID”],
  “columns[ORDER_DATE]”: [ “CLIENT_NAME/payments/created”],
  “columns[ORDER_VALUE]”: [ “CLIENT_NAME/payments/price”]
}
```

In case a variable is represented by multiple columns, the system may perform the calculation in several steps:

Compose a full set of columns which represent all required variables for KPI calculation.

Select a subset of columns which represent all required variables and can be used for calculation. The system may search for the first available condition:

Select a subset of columns which belong to the same table;

Select a subset of columns which belong to joinable tables (we know that from the source data structure);

Select a subset of columns which belong to the same source and can be correlated by timeframe (we know that from the source data structure);

Select a subset of columns which can be correlated by timeframe (we know that from the multiple sources data structures);

Skip calculation if none available.

Run the calculation against available subset of columns.

The system may need to perform some additional processing of the tagged data depending on the identified data types: (1) format conversion and (2) value normalization. (1) Format conversion is needed in most cases since data sources may use various formats, e.g. it's most obvious for date and time presentation, which can be presented as YYYY-MM-DD, Year/Month/Day, Year/Day/Month, etc. Another example is boolean data type which can be presented in a data set as “true/false”, “yes/no”, “I/O”, “+/−” etc. (2) Another step of data type processing is value normalization. An example of such processing could be normalization of categorical data types, e.g. a product category can be presented as “clothes”, “apparel”, “garment” and a specific synonym map will be needed if a certain KPI mapping formula (e.g. total sales by category) requires the system to group all objects of such category in one bucket.

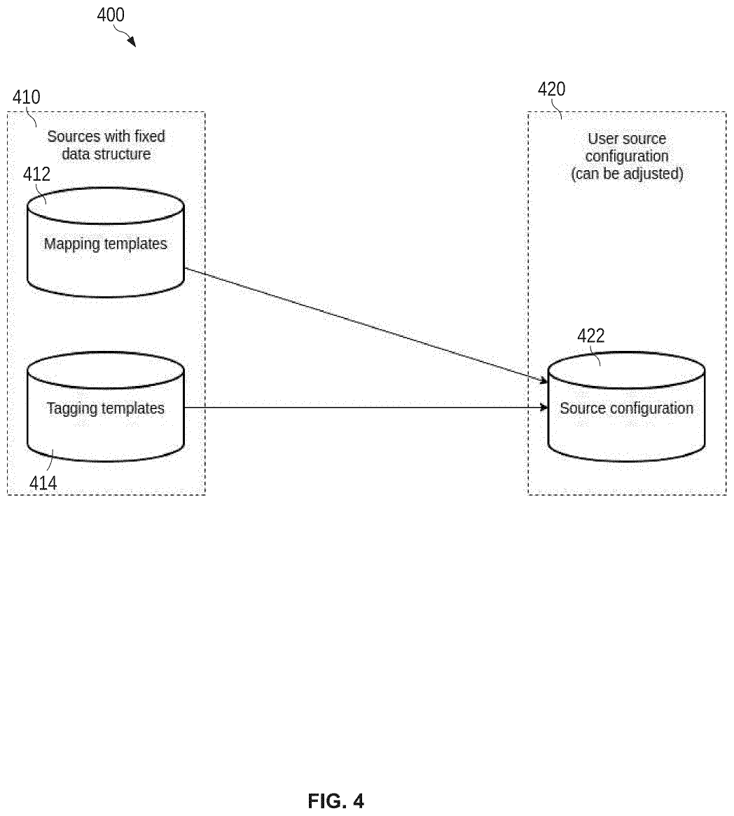

In some embodiments, predetermined mapping and tagging templates may be used for client data sources with fixed (or at least partially fixed) data structures (e.g. Google® Analytics, developed by Google Inc. of Mountain View, Calif.). This is shown in FIG. 4, a block diagram 400 illustrating data mapping using data sets formatted using preexisting data templates according to one or more embodiments of the disclosure. In case a client adds a data source 410 which has appropriate mapping templates 412 and tagging configuration templates 414, these templates will be copied directly to the user's source configuration 420. These templates provide basic and general configuration. Any specific user's data source configuration 422 can be changed anytime to meet the user's needs.

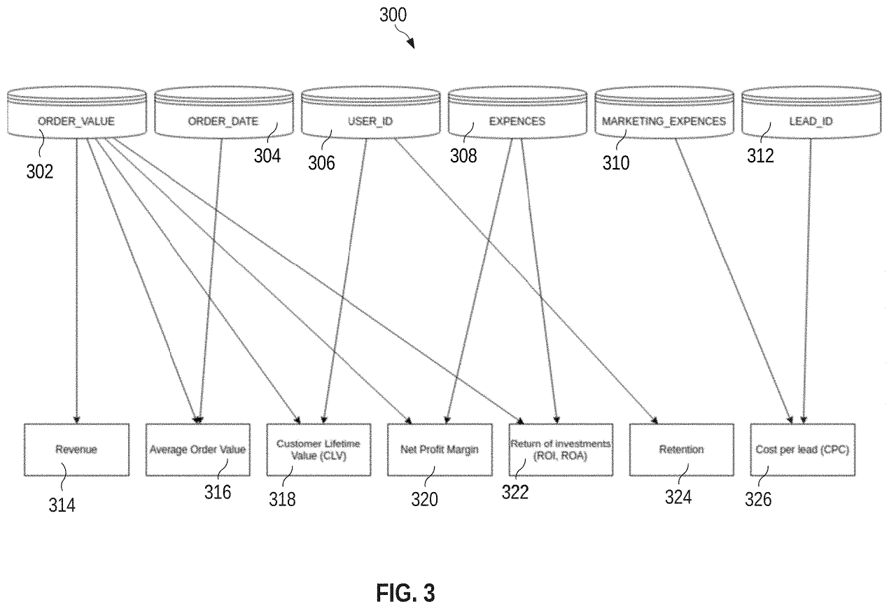

After the mapping has taken place, a plurality of performance indicators may be determined from the performance indicator inputs at block 220. In an embodiment, using the mapped data set a virtual company model may then be generated, where the virtual company model is a graph with data sources (variables) acting as root nodes and performance indicators on leaf nodes. FIG. 3 is a block diagram of a virtual company model 300 linking data sources and performance indicators according to one or more embodiments of the disclosure. As seen in model 300, the data sources 302, 304, 306, 308, 310, and 312 are root nodes linked to associated performance indicators 314, 316, 318, 320, 322, 324, and 326. Once the system calculates all available KPIs—all the results together are stored as a company performance snapshot. These snapshots are used to match actionable recommendation templates against them. Incoming connections for a node mean that specific KPI might be calculated only if all the incoming connections are fulfilled (system has required data for all root elements).

KPIs are used to calculate a company's performance by different metrics. The described system uses general formulas to calculate KPIs (similar to pseudo code), and substitutes formula parameters depending on various factors (user request, current time frame, amount of data, etc). Once the system calculates all available KPIs—all the results together are stored as a company performance snapshot. These snapshots are used to match actionable recommendation templates against them. Table 1 below displays various performance indicators and exemplary code that may be used to determine the performance indicators.

TABLE 1
List of exemplary KPI determination formula

| KPI (Metric) | Pseudo code |
|---|---|
| Average Order Value | avg(ORDER_ VALUE) per ORDER_DATE |
| Bounce rate | BOUNCE_RATE per BOUNCE_DATE |
| Customer Lifetime Value (CLV) | avg(ORDER_VALUE) per USER_ID |
| Net Profit Margin | sum(ORDER_VALUE) − sum(EXPENCES) |
| Return of investments (ROI, ROA) | (sum(ORDER_VALUE) − sum(EXPENCES)) / sum(EXPENCES) |
| Retention | count(DISTINCT USER_ID period N) − count(USER_ID in |
| | LIST_USER_ID period N-1) / count(DISTINCT USER_ID perion |
| | N-1) |
| Revenue | sum(ORDER_VALUE) |
| Cost per lead (CPC) | sum(MARKETING_EXPENCES) / count(DISTINCT LEAD_ID) |
| Conversion rate (funnel) | sum(LEVEL=N) / sum(LEVEL=N+1) |
| Average Sales Cycle Length | count(UNIQUE ORDER_DATE) / sum(BOOL Flag deal) |
| Click through rate (CTR) | CTR per CTR_DATE |
| Cost of Customer Acquisition (CAC) | sum(EXPENCES) / count(DISTINCT USER_ID) |
| Lead Response Time | sum(LEAD_ANSWER_DATE-LEAD_START_DATE) / |
| | count(DISTINCT LEAD_ID) |
| Response rate | avg(BOOL Flag answered calls) |
| Revenue per customer | sum(ORDER_VALUE) / count(DISTINCT USER_ID) |
| Revenue per FTE | sum(ORDER_VALUE) / count(DISTINCT EMPLOYEE_ID) |
| Customer Return Rate | avg(BOOL Flag rejected goods) |
| Acid-Test Ratio | (sum(CASH) + Sum(MARKETABLE_SECURITIES) + |
| | sum(ACCOUNTS_RECEIVABLE)) / sum(LIABILITIES) |
| Avoided Cost | sum(ASSUMED_REPAIR_COST) + |
| | sum(PRODUCTION_LOSSES) − sum(PREVENTION_COST) |
| Capacity Utilization | sum(PRODUCED_GOODS) / sum(MAX_PRODUCTION_PLAN) |
| Customer Satisfaction Score (CSAT) | avg(BOOL Flag customer_mark IN [4,5]) per USER_ID |
| Debt To Equity Ratio | sum(LIABILITIES) / sum(EQUITY) |
| Dormancy Rate | avg(BOOL Flag LAST_VISIT_DATE is not NULL) per USER_ID |
| Employee Absence Rate | avg(BOOL Flag STATUS=ABSENT) per EMPLOYEE_ID |
| Employee Turnover Rate | avg(BOOL Flag STATUS=LEFT) per EMPLOYEE_ID |
| First Pass Yield (FPY) | avg(BOOL QUALITY_CONTROLL) |
| First Response Time (FRT) | sum(MIN(TICKET_ANSWER_DATE)−TICKET_START_DATE) / |
| | count(DISTINCT TICKET_ID) |
| Free Cash Flow (FCF) | sum(EBIT) + sum (DEPRECIATION) + sum(TAXES) − |
| | (sum(WORKING CAPITAL period N+1) − sum(WORKING |
| | CAPITAL period N)) − sum(CAPITAL_EXPEDITURES) |
| Levered Cash Flow (LCF) | sum(EBITDA) + sum (DEPRECIATION) − (sum(WORKING |
| | CAPITAL period N+1) − sum(WORKING CAPITAL period N)) − |
| | sum(CAPITAL_EXPEDITURES) − sum(DEBT_PAYMENTS) |
| Net Present Value (NPV) | sum(CASH_EXPECTED) / sum(CASH_INVESTED) |
| Net Promoter Score (NPS) | (count(QUESTION_WILL_YOU_ADVICE_APP_FREIEND=YES) − |
| | count(QUESTION_WILL_YOU_ADVICE_APP_FREIEND=NO)) / |
| | count(QUESTION_WILL_YOU_ADVICE_APP_FREIEND IS NOT |
| | NULL) |
| On-Time Delivery | avg(BOOL Flag IS_DELAYED) |
| Operating Cash Flow | sum(EBIT) + sum (DEPRECIATION) + sum(TAXES) − |
| | (sum(WORKING CAPITAL period N+1) − sum(WORKING |
| | CAPITAL period N)) |
| Payroll Headcount Ratio | avg(BOOL Flag POSITION_TYPE=FULL_TIME) per |
| | EMPLOYEE_ID |
| Return on assets | (sum(ORDER_VALUE) − sum(NET_COST)) / sum(ASSETS) |
| Return on Equity (ROE) | (sum(ORDER_VALUE) − sum(EXPENCES)) / |
| | sum(STACKEHOLDERS EQUITY) |
| Working Capital Ratio | sum(ASSETS) / sum(LIABILITIES) |

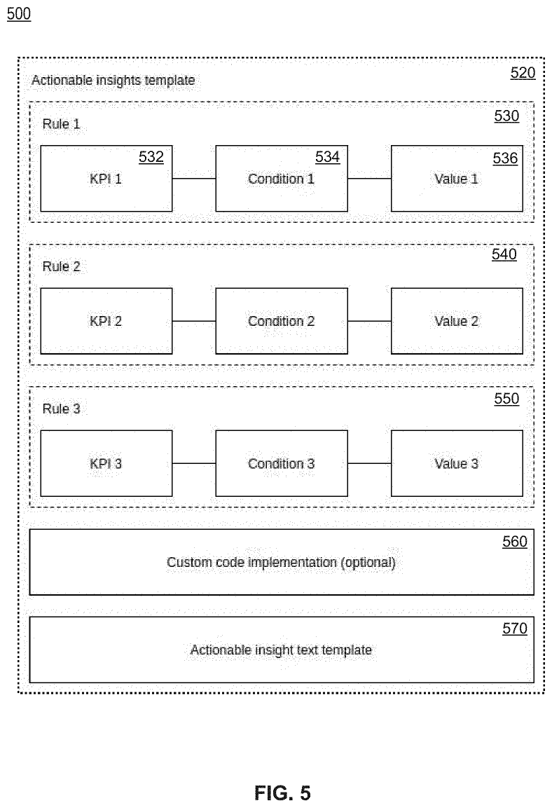

A selected insight template may then be retrieved, by the server, from a plurality, of insight templates stored within a template database at block 225. The retrieved insight template may be selected based on the determined performance indicators matching input requirements of the selected insight template. FIG. 5 is a block diagram 500 illustrating an exemplary insight data structure according to one or more embodiments of the disclosure. Each insight template 520 stored within the template database may be stored as a data object that includes a plurality of rules 530, 540, and 550. Each template may include multiple rules which apply restrictions on the current company performance snapshot. Rules may be defined as simple restrictions (logical operators with fixed values).

Each rule may receive one or more performance indicators 532 as inputs and derive a rule output 536 from the received performance indicators using a condition 534. The data object of each insight template may also include narrative text 570 that provides a text recommendation based on the rule outputs (such as rule output value 536). Actionable insight text templates 570 may contain text which supports variable interpolation. Variables may be calculated by the custom code 560 or be taken directly from the company performance snapshot (e.g., using specific KPIs). In some embodiments, a custom code implementation 560 may be included, for example, to derive one or more visualizations based on the rule outputs from rules 530, 540, and 550. Custom code 560 may also be used for complex calculations (e.g. specific values in actionable insight text or custom complex rules). Some exemplary insight templates might contain no rules, and may only evaluate custom code to generate actionable insights.

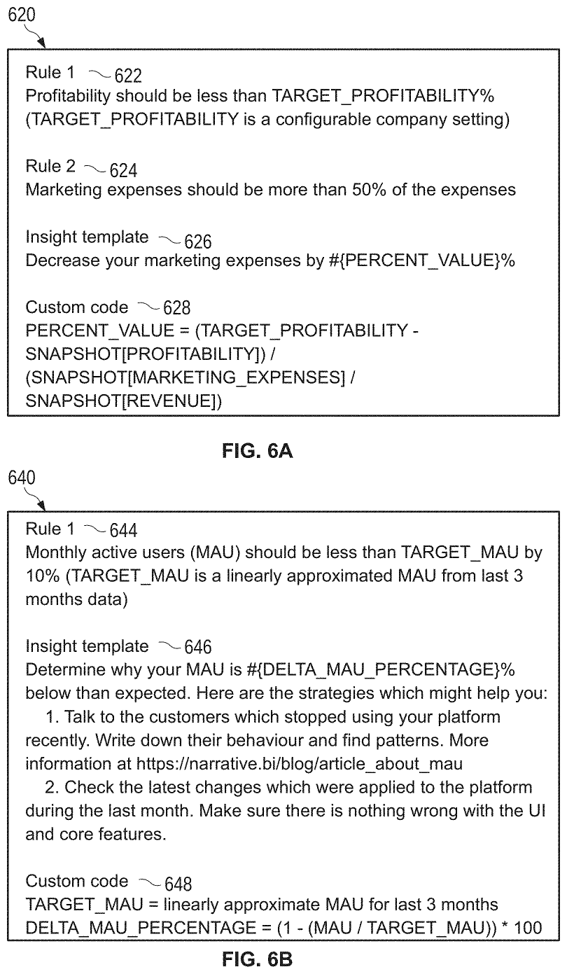

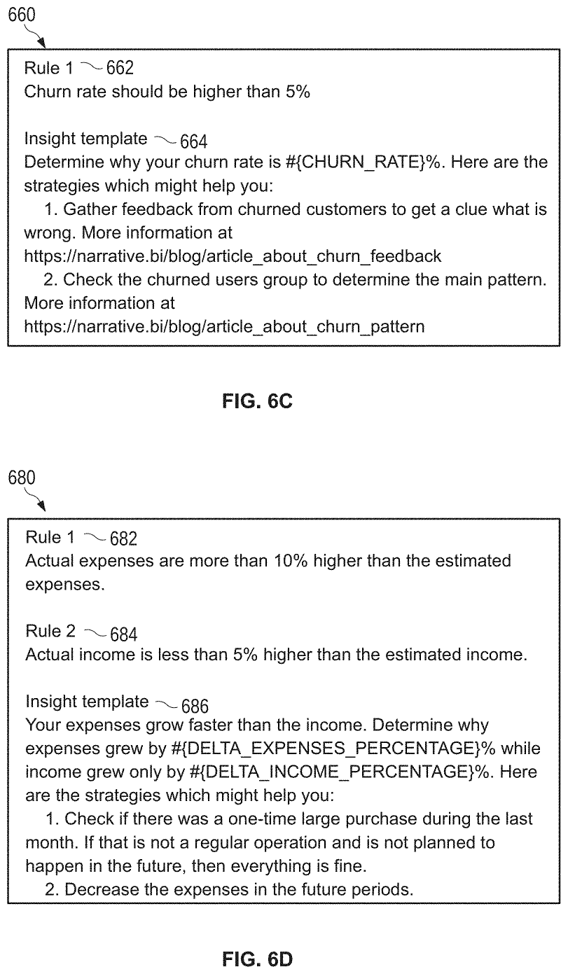

FIGS. 6A-D show exemplary insight templates 620, 640, 660, and 680 according to one or more embodiments of the disclosure. Each template, which may be stored within a template database, includes one or more rules 622, 624, 644, 662, 682, and 684, and narrative text in the form of insight templates 626, 646, 664, and 686. Some of the insight templates shown include custom code 628 and 648, used for more complex determinations.

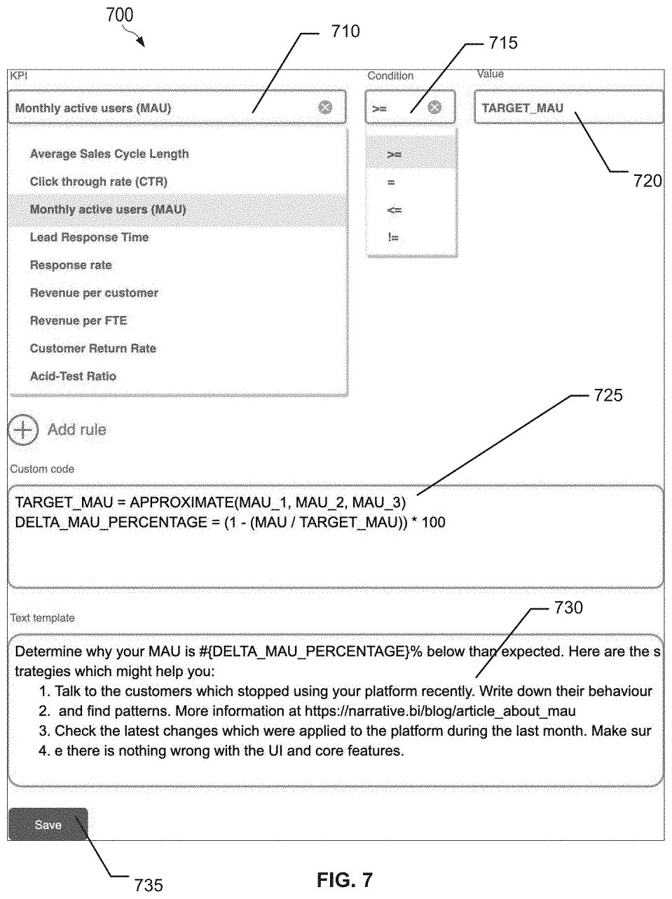

When a new client data source is added, the information about the source and data structure inside that source may be used to create a list of KPIs (metrics) which can be calculated using the data from the new source. After that, a user may compose another list of actionable insights which can be created using available KPIs and data. These specific insights may be added to an actionable insights template database by, for example, using an insight template form. FIG. 7 is a screenshot 700 illustrating configurable settings for an insight template according to one or more embodiments of the disclosure. As shown in screenshot 700, the insight template intake form may include selectable options for performance indicators 710, the condition for a rule 715, and the rule output name 720. Input areas for custom code 725 and narrative text 730 may also be included. Once a user has finished inputting at least one rule and the narrative text for the new insight template, the insight template may be saved to the template database by the user selecting save button 735.

In an exemplary embodiment, the system may select only applicable actionable insight templates by vertical and time frame. Some insights might not have a specific vertical; in that case they are matched to any vertical. As a second step, the system matches all applicable actionable insight templates against the current company performance snapshot. If all template conditions are satisfied, the recommendation will be generated and added to the insight automatically.

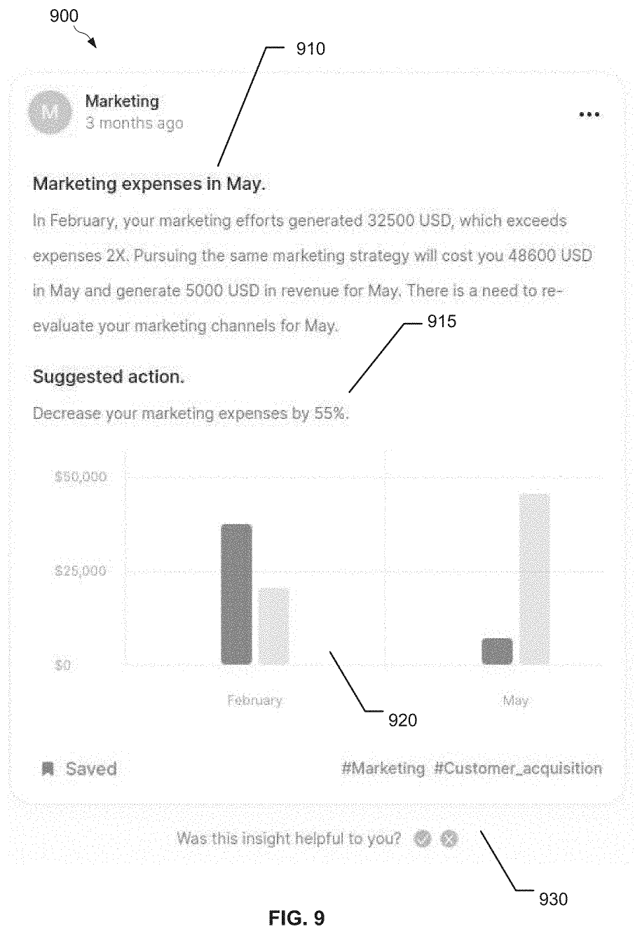

Returning to method 200, the server may then execute the rules included within the selected insight template at block 230 using the determined plurality of performance indicators for the received data set. After the rules have been executed, the server may transmit, via the network connection, the narrative text and the rule outputs to a display device (such as user interface 160) at block 235. The server may then cause an insight graphic interface to be displayed by the display device, where the insight graphic interface includes the text recommendation, at block 240. FIG. 9 is a screenshot 900 illustrating an insight graphic interface according to one or more embodiments of the disclosure. The exemplary insight graphic interface may include the narrative text 910 complete with any values included in the narrative text. A recommendation 915 is also included as part of the narrative text recommending what actions the user can take to improve the performance indicators. Exemplary insight graphic interface 900 also includes visualization 920 derived from the performance indicators. Finally, feedback features 930 allow a user to provide feedback, which may be used as input to method. 800, for example.

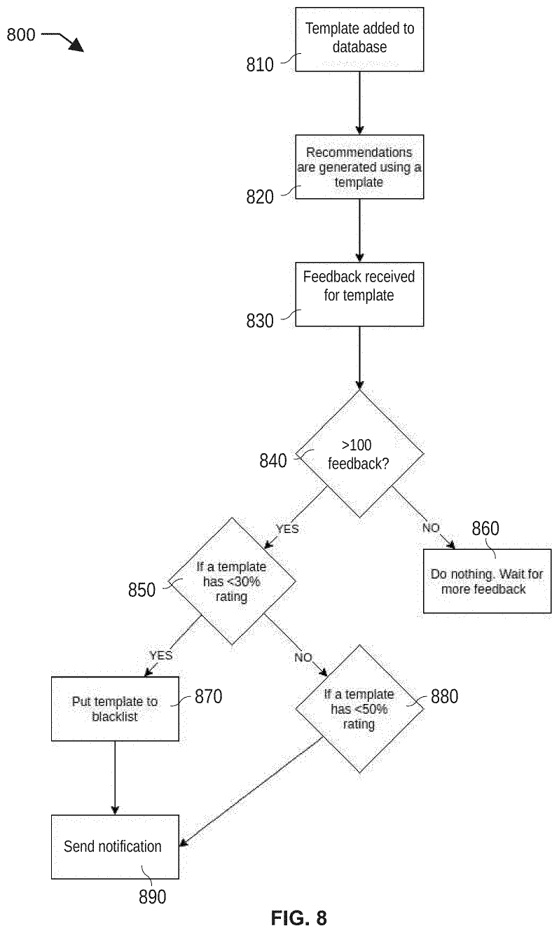

Some embodiments of the present invention may also allow the user the system to configure which types of actionable insights should be displayed or hidden in the output of the system. Depending on the specific business setup, certain KPIs might appear to be more or less important in the decision making process, therefore allowing the user to mark those KPIs as important or not important may provide additional value and make the system more usable, FIG. 8 is a flow diagram illustrating an example method of utilizing user feedback for insight templates according to one or more embodiments of the disclosure. After a insight template is added to the database at block 810, a recommendation template may be generated for the insight template at block 820. The template may allow users to provide feedback on the quality and business value of the generated insights, e.g. by adding “like” and “dislike” buttons in the user interface associated with the recommendation template. At block 840, the amount of feedback may be tallied for the insight template and compared to a threshold (e.g. 100 in the exemplary embodiment). When there is fewer than the threshold amount of feedback received, no action is taken at block 860. When the threshold is met, the method 800 proceeds to block 850, where a determination is made if the insight template has less than a second threshold amount of positive reviews. If the number of positive feedback reviews is less than the second threshold, the insight template may be added to a blacklist at block 870 and removed from the template database until further action by an administrator. At block 880, when the insight template has more than the minimum second threshold of positive feedback, another determination is made, to see if the insight template has greater than a third threshold of positive feedback. When the template has more than the third threshold of positive feedback (e.g., 50%), a notification may be automatically generated and transmitted to an administrator to flag the insight template as particularly useful. Such feedback information collected from the user, may be used by the system to decide whether to display or hide such insights from the user in the future.

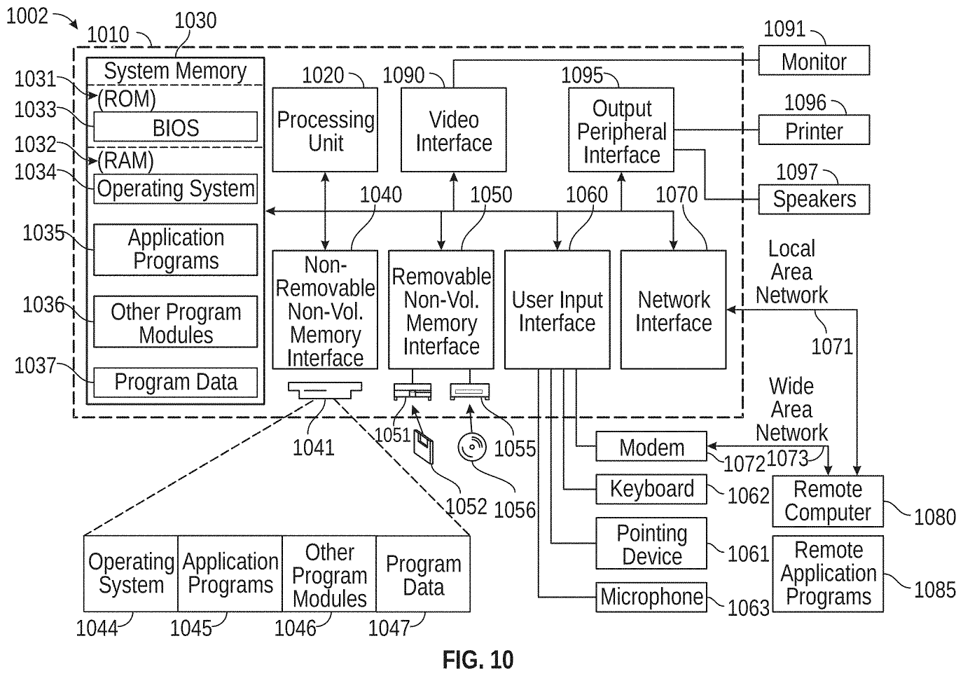

FIG. 10 is a diagram of an example computing system that may be used with some embodiments of the present invention. The computing system 1002 is only one example of a suitable computing system, such as a mobile computing system, and is not intended to suggest any limitation as to the scope of use or functionality of the design. Neither should the computing system 1002 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 1002 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 10, the computing system 1002 may include, but are not limited to, a processing unit 1020 having one or more processing cores, a system memory 1030, and a system bus 1021 that couples various system components including the system memory 1030 to the processing unit 1020, The system bus 1021 may be any of several types of bus structures including a memory bus or memory controller, a peripheral bus, and a local bus using any of a variety of bus architectures, By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 1002 typically includes a variety of computer readable media. Computer readable media can be any available media that can be accessed by computing system 1002 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD)) or other optical disk storage, magnetic cassettes, magnetic tape, magnetic disk storage or other magnetic storage devices, or any other medium which can be used to store the desired information and which can be accessed by computing system 1002. Communication media typically embodies computer readable instructions, data structures, or program modules.

The system memory 1030 may include computer storage media in the form of volatile and/or nonvolatile memory such as read only memory (ROM) 1031 and random access memory (RAM) 1032. A basic input/output system (BIOS) 1033, containing the basic routines that help to transfer information between elements within computing system 1002, such as during start-up, is typically stored in ROM 1031. RAM 1032 typically contains data and/or program modules that are immediately accessible to and/or presently being operated on by processing unit 1020. By way of example, and not limitation. FIG. 10 also illustrates operating system 1034, application programs 1035, other program modules 1036, and program data 1037.

The computing system 1002 may also include other removable/non-removable volatile/nonvolatile computer storage media. By way of example only, FIG. 10 also illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computing system 1002. In FIG. 10, for example, hard disk drive is illustrated as storing operating system 1044, application programs 1045, other program modules 1046, and program data 1047. Note that these components can either be the same as or different from operating system 1034, application programs 1035, other program modules 1036, and program data 1037. The operating system 1044, the application programs 1045, the other program modules 1046, and the program data 1047 are given different numeric identification here to illustrate that, at a minimum, they are different copies.

A user may enter commands and information into the computing system 1002 through input devices such as a keyboard 1062, a microphone 1063, and a pointing device 1061, such as a mouse, trackball or touch pad or touch screen. Other input devices (not shown) may include a joystick, game pad, scanner, or the like. These and other input devices are often connected to the processing unit 1020 through a user input interface 1060 that is coupled with the system bus 1021, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1090.

The computing system 1002 may operate in a networked environment using logical connections to one or more remote computers, such as a remote computer 1080. The remote computer 1080 may be a personal computer, a hand-held device, a server, a router, a network PC, a peer device or other common network node, and typically includes many or all of the elements described above relative to the computing system 1002. The logical connections depicted in FIG. 5 include a local area network (LAN) 1071 and a wide area network (WAN) 1073, but may also include other networks. Such networking environments are commonplace in offices, enterprise-wide computer networks, intranets and the Internet.

When used in a LAN networking environment, the computing system 1002 may be connected to the LAN 1071 through a network interface or adapter 1070. When used in a WAN networking environment, the computing system 1002 typically includes a modern 1072 or other means for establishing communications over the WAN 1073, such as the Internet. The modem 1072, which may be internal or external, may be connected to the system bus 1021 via the user-input interface 1060, or other appropriate mechanism. In a networked environment, program modules depicted relative to the computing system 1002, or portions thereof, may be stored in a remote memory storage device. By way of example, and not limitation, FIG. 5 illustrates remote application programs 1085 as residing on remote computer 1080. It will be appreciated that the network connections shown are exemplary and other means of establishing a communications link between the computers may be used.

It should be noted that some embodiments of the present invention may be carried out on a computing system such as that described with respect to FIG. 5. However, some embodiments of the present invention may be carried out on a server, a computer devoted to message handling, handheld devices, or on a distributed system in which different portions of the present design may be carried out on different parts of the distributed computing system.

Another device that may be coupled with the system bus 1021 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 1072 may employ a Wireless Application Protocol (WAP) to establish a wireless communication channel. The communication module 1072 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

In the description above and throughout, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of the preferred an embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure,

What is claimed is:

1. A method comprising:
tagging, by a server, data columns of a data set received from a client device over a network connection;
mapping, by the server, the tagged data columns to a plurality of performance indicator inputs;
determining, by the server, a plurality of performance indicators based on the performance indicator inputs;
retrieving, by the server from a template database, a selected insight template from a plurality of insight templates stored within the template database, the selected insight template being retrieved based on the determined performance indicators matching input requirements of the selected insight template, each insight template stored within the template database including a data object comprising a plurality of rules that receive performance indicators as inputs and derive rule outputs from the received performance indicators, and narrative text that provides a text recommendation based on the rule outputs;
executing, by the server, the rules included within the selected insight template using the determined plurality of performance indicators;
transmitting, by the server via the network connection, the narrative text and the rule outputs to a display device; and
causing, by the server, an insight graphic interface to be displayed by the display device, the insight graphic interface including the text recommendation.

2. The method of claim 1, where the narrative text integrates the rule inputs into the text in an explanation of the text recommendation.

3. The method of claim 1, where each insight template stored within the template database is associated with user feedback within the database, where negative user feedback meeting a predetermined threshold for one of the insight templates causes the one of the insight templates to be added to a blacklist that causes the one of the insight templates to not be matched against incoming performance indicators.

4. The method of claim 1, wherein the performance indicators are calculated using additional data sets retrieved from one or more external data sources via the network connection.

5. The method of claim 4, the one or more external data sources including a publicly available data source.

6. The method of claim 1, the insight graphic interface further comprising at least one visualization of the rule outputs, the visualization of the rule outputs being at least one of an image, a chart, an icon, and a table.

7. A system comprising:
one or more processors; and
a non-transitory computer-readable medium storing a plurality of instructions, which when executed, cause the one or more processors to:
tag data columns of a data set received from a client device over a network connection;
map the tagged data columns to a plurality, of performance indicator inputs;
determine a plurality of performance indicators based on the performance indicator inputs;
retrieve, from a template database, a selected insight template from a plurality of insight templates stored within the template database, the selected insight template being retrieved based on the determined performance indicators matching input requirements of the selected insight template, each insight template stored within the template database including a data object comprising a plurality of rules that receive performance indicators as inputs and derive rule outputs from the received performance indicators, and narrative text that provides a text recommendation based on the rule outputs;
execute the rules included within the selected insight template using the determined plurality of performance indicators;
transmit, via the network connection, the narrative text and the rule outputs to a display device; and
cause an insight graphic interface to be displayed by the display device, the insight graphic interface including the text recommendation.

8. The system of claim 7, where the narrative text integrates the rule inputs into the text in an explanation of the text recommendation.

9. The system of claim 7, where each insight template stored within the template database is associated with user feedback within the database, where negative user feedback meeting a predetermined threshold for one of the insight templates causes the one of the insight templates to be added to a blacklist that causes the one of the insight templates to not be matched against incoming performance indicators.

10. The system of claim 7, wherein the performance indicators are calculated using additional data sets retrieved from one or more external data sources via the network connection.

11. The system of claim 10, the one or more external data sources including a publicly available data source.

12. The system of claim 7, the insight graphic interface further comprising at least one visualization of the rule outputs, the visualization of the rule outputs being at least one of an image, a chart, an icon, and a table.

13. A non-transitory computer readable storage medium having embodied thereon a program, the program being executable by a processor for performing a method comprising:
tagging data columns of a data set received from a client device over a network connection;
mapping the tagged data columns to a plurality of performance indicator inputs;
determining a plurality of performance indicators based on the performance indicator inputs;
retrieving, from a template database, a selected insight template from a plurality of insight templates stored within the template database, the selected insight template being retrieved based on the determined performance indicators matching input requirements of the selected insight template; each insight template stored within the template database including a data object comprising a plurality of rules that receive performance indicators as inputs and derive rule outputs from the received performance indicators, and narrative text that provides a text recommendation based on the rule outputs;
executing the rules included within the selected insight template using the determined plurality of performance indicators;
transmitting, via the network connection, the narrative text and the rule outputs to a display device; and
causing an insight graphic interface to be displayed by the display device, the insight graphic interface including the text recommendation.

14. The non-transitory computer-readable storage medium of claim 13, where the narrative text integrates the rule inputs into the text in an explanation of the text recommendation.

15. The non-transitory computer readable storage medium of claim 13, where each insight template stored within the template database is associated with user feedback within the database, where negative user feedback meeting a predetermined threshold for one of the insight templates causes the one of the insight templates to be added to a blacklist that causes the one of the insight templates to not be matched against incoming performance indicators.

16. The non-transitory computer readable storage medium of claim 13, wherein the performance indicators are calculated using additional data sets retrieved from one or more external data sources via the network connection.

17. The non-transitory computer readable storage medium of claim 16, the one or more external data sources including a publicly available data source.

18. The non-transitory computer-readable storage medium of claim 13, the insight graphic interface further comprising at least one visualization of the rule outputs, the visualization of the rule outputs being at least one of an image, a chart, an icon, and a table.
